(19) United States
(12) Patent Application Publication
(10) Pub. No.: US 2003/0145203 A1
(43) Pub. Date: Jul. 31, 2003

(54) System and method for performing mutual authentications between security tokens

(76) Inventors: Yves Audebert, Los Gatos, CA (US); Wu Wen, Santa Clara, CA (US)

Correspondence Address: STEVENS, DAVIS, MILLER & MOSHER, L.L.P., Suite 850, 1615 L Street, N.W., Washington, DC, 20036, US

(21) Appl. No.: 10/058,734

(22) Filed: Jan. 30, 2002

(51) Int. Cl. H04L 9/00

(52) U.S. Cl. 713/169

(57) ABSTRACT

This patent describes a data processing system and method for performing mutual authentications between two security tokens by generation of a common cryptographic key. The common cryptographic key is generated using unique identifiers associated with each security token that diversify a common master key. The generation process incorporates a message digest function such as SHA-1 and an XOR operator to arrive at the common symmetric key.

### FIELD OF INVENTION

The present invention relates to a data processing system and method for performing mutual authentications between security tokens using a commonly generated symmetric key.

### BACKGROUND OF INVENTION

There are a number of mechanisms available in the current art for performing mutual authentications between two or more security tokens, where security tokens refers to personal security devices (PSD) such as smart cards, subscriber identification modules (SIM), wireless identification modules (WIM), identification tokens, integrated circuit cards (IC cards), hardware security modules (HSM) and related devices. Many of these mechanisms are intended for implementation over a communications network between a local terminal and remote host service provider but still may be useful in localized authentications.

Localized authentication mechanisms for use in security tokens generally rely on symmetric keys rather than asymmetric key mechanisms due to the limited storage space available, speed of execution and limited processing capabilities of the security tokens. Regardless of the mechanisms employed, the main goals of these mechanisms are intended to simplify key management and/or maintain robust security against unauthorized information disclosure.

For example, U.S. Pat. No. 4,912,762 to Lee et al. describes a cryptographic key management method intended for use between a banking host and a group of networked terminals such as automatic teller machines (ATM). In this patent, unique identifier information belonging to the host and a terminal are encrypted using a symmetric “base” key owned by the other (host or terminal.) A common key is generated using both encrypted unique identifiers by utilizing a bit wise exclusive OR operator.

This method relies on physical security measures at the ATM location in order to protect its installed terminal base key, which is not practical for implementation in less secure operating environments. In addition, the use of at least two symmetric keys increases the administrative burden associated with key management, particularly when a large number of terminals and hosts are interconnected.

In a second approach, U.S. Pat. No. 5,602,915 to Campana et al. describes a method of controlling symmetric keys between two smart cards. This approach utilizes common symmetric keys and an identical random number to generate a unique session key based on each card's unique identifiers processed by a commutative algorithm common to both cards. This approach simplifies key management since fewer keys need to be distributed and maintained. However, a significant disadvantage in employing this technique resides in the use of a common random number and the nonsecret unique identifiers to generate the common session key. Disclosure of the components involved in generating the common session key (random number and unique identifiers) could be used to uncover the base symmetric key installed in all cards within the group possessing the based symmetric key.

In a third approach, U.S. Pat. No. 5,729,609 to Moulart et al. describes a method of generating and using a common cryptographic key between two devices. This method utilizes a series of symmetric keys installed in a pair of devices such as smart cards. A significant advantage of this method over previously described methods is that a compromise of the cryptographic information in one device does not disclose cryptographic information contained in the complementary device. A limitation of this methodology is the reliance on multiple key sets in order to achieve a secure result. Multiple key sets necessarily require greater administrative and other controls in order to maintain the system.

In a forth approach, U.S. Pat. No. 5,745,576 to Abraham et al. describes a simple method of initializing a terminal. In this approach, a “controller” such as an intelligent embedded device or server contains cryptographic algorithms and data to generate cryptographic keys based on the unique identification numbers supplied by interconnected terminals. This approach allows generation of cryptographic keys which are used for identifying and authenticating interrogated terminals based on a common “base key” owned by the controller and diversified with the unique ID of one or more interconnected terminals. This method is simple to implement but lacks sufficient robustness to be used in most applications without additional security measures.

Lastly, in a fifth approach, U.S. Pat. No. 6,282,649 to Lambert et al. describes a method where a personal identification number (PIN) entry or other unique identifier such as biometric data is combined with pre-determined data to generate a user key which provides access rights to applications. This method while simple is limited to local transactions preferably within the secure domain of a smart card or similar device. If used over public networks, a sophisticated attacker could eventually determine either the PIN, the pre-determined data or both.

Thus, it is apparent that a relatively simple symmetric key system, which provides reasonable security in localized authentications between security tokens, would represent an improvement over the prior art. Such an improvement is proposed in the disclosure for the invention that follows.

### SUMMARY OF INVENTION

This invention provides a system and method for performing authentications between local security tokens using a common symmetric key generated from components contained within the secure domains of the security tokens. Once the common key is generated, authentication transactions are performed using the common key.

In order to practice this invention, a master group key is generated preferably within the secure domain of a hardware security module. The master group key is then diversified using a unique identifier associated with each security token. The diversification is performed by performing a message digest of the unique identifier and performing an exclusive OR (XOR) bit-wise operation using the hashed unique identifier and master group key as operands. The resulting key, hereinafter called a base key, is then installed in each security token to be associated with the group. The base keys may be installed in the security tokens at time of initial personalization or post issuance.

To generate a common key, hereinafter called a composite group key, an exchange is initiated which communicates each security token's unique identifier to the other token to be authenticated. Each unique identifier is then hashed internally and the result of which is XOR'd with the internal base key forming a composite group key. The message digest is preferably performed using Secure Hash Algorithm-1 (SHA-1), although other message digesting techniques such as Message Digest 5 (MD5) or RACE Integrity Primitives Evaluation Message Digest 160 (RIPEMD-160) may be employed as well so long as all tokens in the group employ the identical algorithms.

In another embodiment of the invention, the message digests of the security token's unique identifiers are sent rather than the actual unique identifier. This alternate embodiment allows for anonymous authentications to occur which may be advantageous in highly insecure operating environments.

Once the composite group keys have been generated, mutual authentication is performed by generating random numbers of sufficient bit length, encrypting the random numbers using the generated control keys and sending the resulting cryptograms to the other security token. Each token decrypts the cryptogram and returns the random number to the issuing token for comparison with the originally generated random number. A mutual match of random numbers by the tokens is used as proof of authentication.

The encryption/decryption algorithm employed is preferably the triple data encryption standard (3DES). Other algorithms employing the advanced encryption standard (AES) Rijndael may be employed as well so long as all tokens within the group utilize the identical algorithm.

### BRIEF DESCRIPTION OF DRAWINGS

FIG. 1—is a system block diagram for generating the base keys used in implementing the invention. This figure depicts the general system arrangement showing the generation of the master group key and resulting base key being injected into the security token.

FIG. 2—is a detailed block diagram illustrating transfer of unique identifiers random numbers and cryptograms between security tokens.

FIG. 3—is a flow chart illustrating the generation and injection of the based key into a security token.

FIG. 4—is a flow chart illustrating the generation of the composite group key used in the authentication process employed by the invention.

FIG. 5—is a flow chart illustrating the first portion of the authentication process where a cryptogram is generated using the composite group key implemented in the invention.

FIG. 6—is a flow chart illustrating the final portion of the authentication process where a received random number is compared with the originally generated random number.

### DETAILED DESCRIPTION OF PREFERRED EMBODIMENT

This invention describes a simple system and method to perform mutual authentications between security tokens using a mutually generated composite cryptographic key.

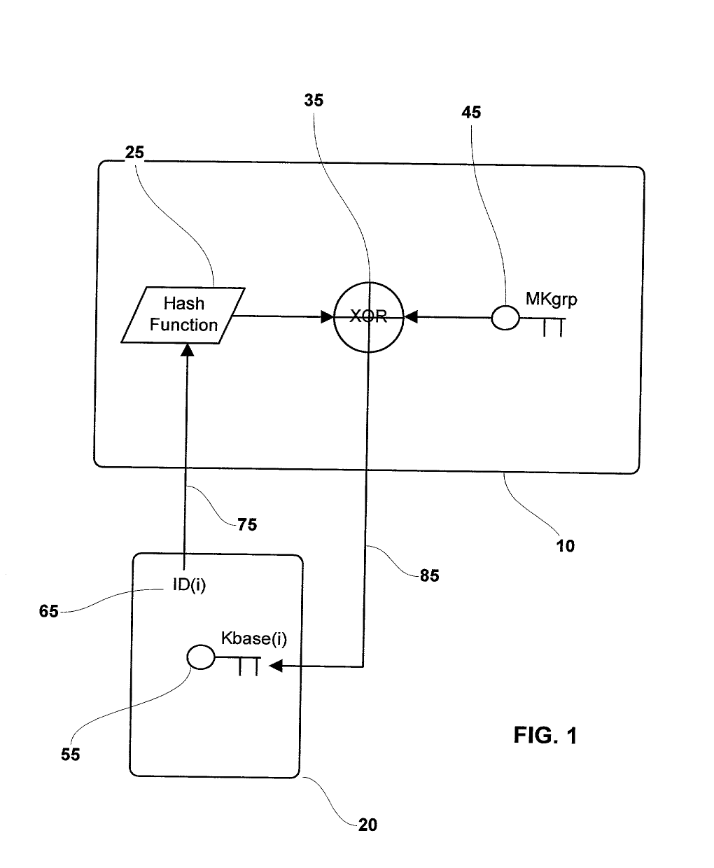

In FIG. 1, a hardware security module (HSM) 10 or other equivalent device generates a symmetric master group key MKgrp 45 within its secure domain. A security token 20 in processing communications with the hardware security module 10, sends 75 its unique identifier ID(i) 65 to the hardware security module 10 or equivalent. In the preferred embodiment of the invention, the unique identifier ID(i) 65 is the non-mutable serial number masked into the ROM of the token at the time of manufacture.

The unique identifier ID(i) 65 is then hashed 25 using a common message digest function such as SHA-1, MD5 or RIPEMD-160. The hash accomplishes two goals, the unique identifier is converted to an unrecognizable value and is decreased in size to that of the master group key MKgrp 45.

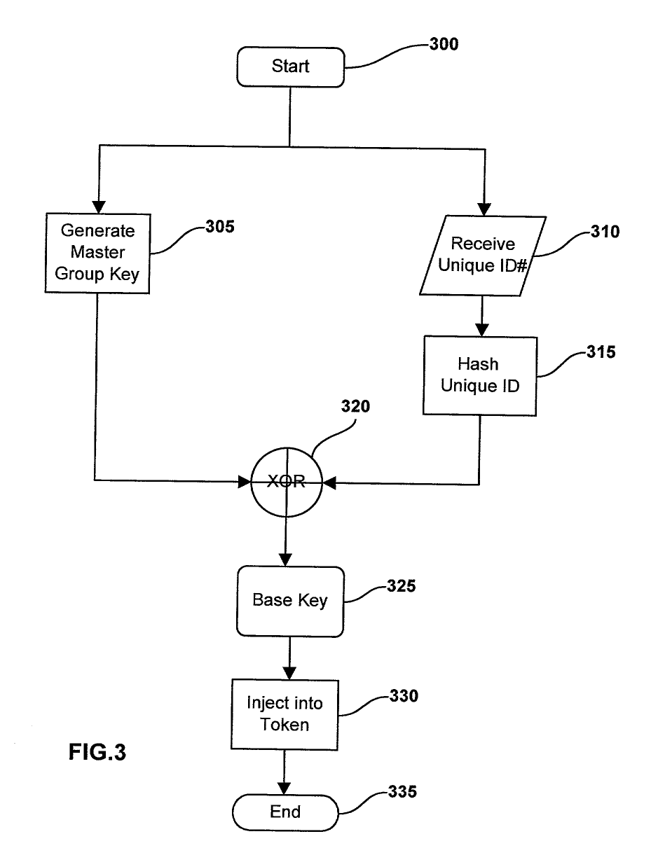

The resulting hash and the master group key MKgrp 45 are used as operands by a exclusive OR bit-wise operator(XOR) 35. The result of the XOR operation is a diversified base key Kbase(i) 55 which is securely and operatively injected 85 into the security token 20. A flow chart that describes the base key generation process is shown in FIG. 3.

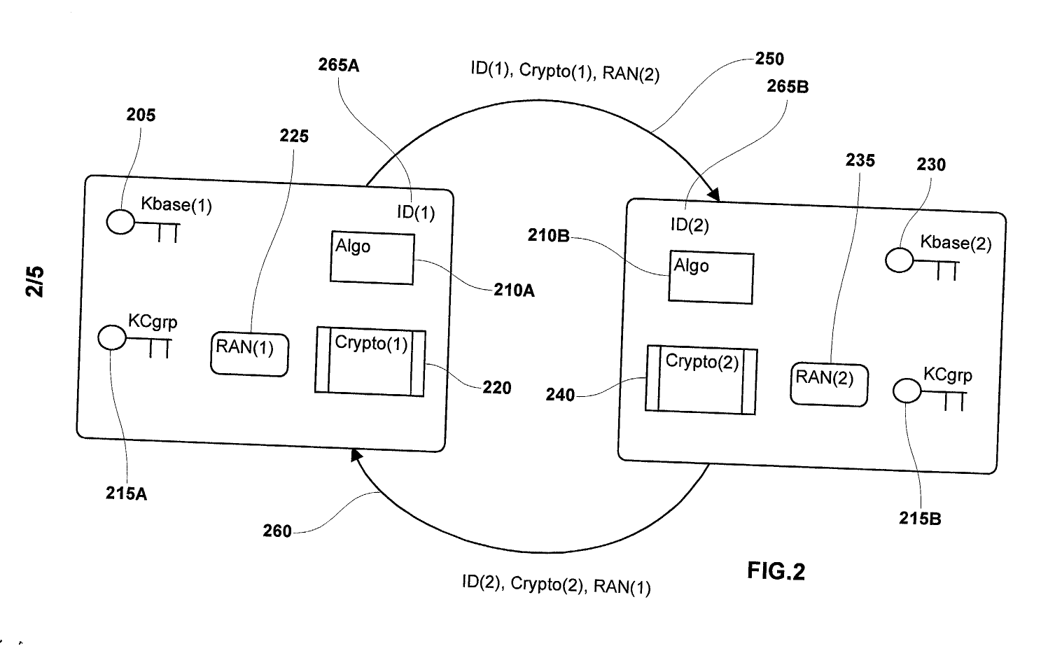

Referring to FIG. 2, to initiate the authentication process, the composite group keys KCgrp 215A, 215B are generated using the exchange 250, 260 of unique identifiers ID(1) 265A and ID(2) 265B between security tokens 20, 30. Each unique identifier ID(1) 265A and ID(2) 265B is processed internally by identical algorithms ALGO 210A, 210B contained within the secure domain of each security token 20, 30. In an alternate embodiment of the invention, the hash of the unique identifiers ID(1) 265A and ID(2) 265B are exchanged to limit disclosure of the information being exchanged.

The algorithms generate the composite group keys KCgrp 215A, 215B using the existing base keys Kbase(1) 205 and Kbase(2) 230 and the exchanged unique identifiers ID(1) 265A and ID(2) 265B: composite group keys KCgrp 215A and 215B are equal, both being a function of master group key MKgrp, first unique identifier ID(1) and second unique identifier ID(2).

Once the composite group keys KCgrp 215A, 215B have been generated, random numbers RAN(1) 225 and RAN(2) 235 are generated within each token 20, 30 and encrypted using the composite group keys KCgrp 215A, 215B forming cryptograms Crypto(1) 220 and Crypto(2) 240.

The cryptograms Crypto(1) 220 and Crypto(2) 240 are exchanged 250, 260, decrypted using each token's composite group keys KCgrp 215A, 215B and the resulting decrypted random numbers returned 250, 260 to the issuing token 20, 30 for comparison with the initially generated random numbers RAN(1) 225 and RAN(2) 235. Mutual authentication is accomplished when both the returned random numbers and existing random numbers RAN(1) 225 and RAN(2) 235 are determined to be identical.

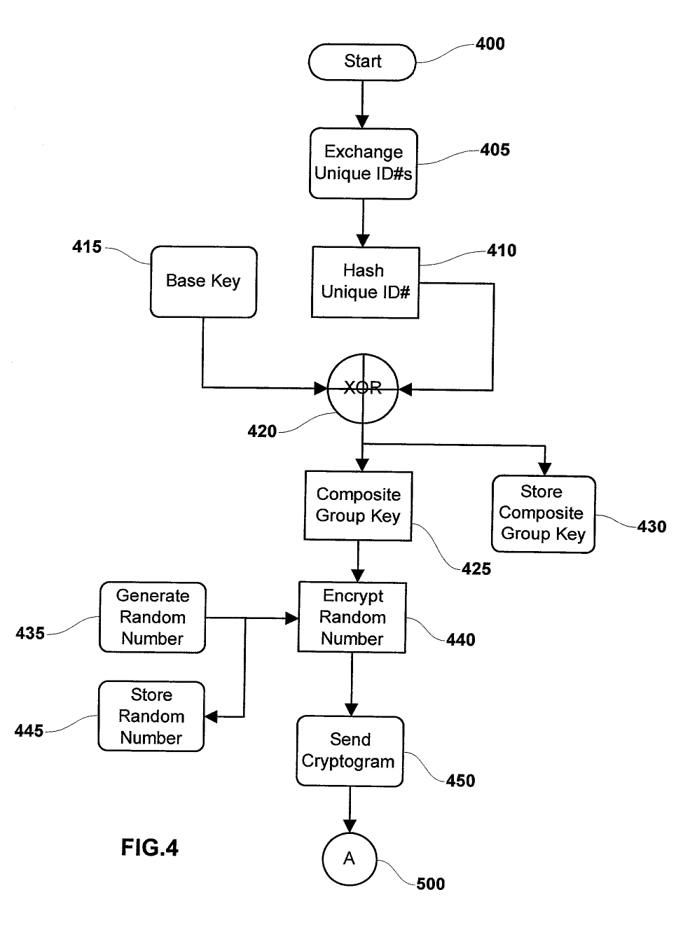

In the preferred embodiment of the invention, the encryption/decryption is accomplished using the triple data encryption standard (3DES). Other algorithms employing the advanced encryption standard (AES) Rijndael may be employed as well so long as all tokens within the group utilize the identical algorithm. Detailed descriptions of the composite key generation and authentication process are provided in the flow charts shown in FIGS. 4, 5 and 6.

Referring to FIG. 3, a flow chart of the base key generation process is depicted. In this portion of the invention, the process is initiated 300 when a unique identifier associated with an opposite security token is received 310 and hashed 315 in a hardware security module (HSM) or equivalent device using a common message digest function such as SHA-1. A second operation generates a master group key 305. The hash value and master group key are used as operands to an exclusive OR bit-wise operator320. The output of the XOR operator forms a unique base key 325 associated with the token whose unique identifier was used in the base key generation process. The generated base key is then securely and operatively injected 330 in the security token, which completes the process 335. This process is repeated for all security tokens intended to authenticate with other security tokens within the group formed using the current version of the master group key.

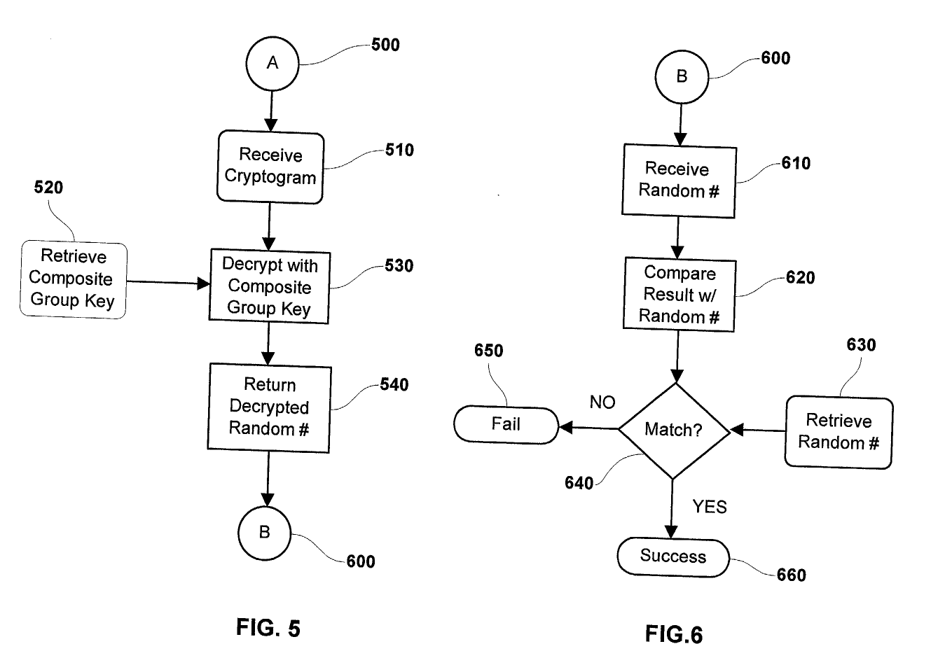

Referring to FIG. 4, a flow chart of the mutual authentication process is depicted. The process is initiated 400 by the exchange of unique identifiers 405 associated with each security token. The unique identifiers are then hashed 410 using a common message digest function such as SHA-1. The resulting hashed unique identifier and the stored base key 415 are used as operands by a exclusive OR bit-wise operator XOR 420. The output of the XOR operator forms the composite group key 425. The composite group key is then stored 430. A random number is generated 435 inside the security token and encrypted 440 using the composite group key. The generated random number is temporarily stored 445. The resulting cryptogram is sent 450 to the opposite security token. This portion of the authentication process continues in FIG. 5 at A 500. In the preferred embodiment of the invention, the encryption/decryption process is accomplished using the triple data encryption standard (3DES.) An identical parallel process occurs on the opposite security token.

Referring to FIG. 5, a flow chart of cryptogram processing is depicted. This portion of the authentication process begins A 500 when the cryptogram is received 510 from the opposite security token. The incoming cryptogram is decrypted 530 using the internally retrieved composite group key 520. The resulting random number is then returned 540 to the sending secure token. This portion of the authentication process continues in FIG. 6 at B 600. An identical parallel process occurs on the opposite security token.

In FIG. 6, a flow chart of returned random number processing is depicted. The final portion of the authentication process is initiated B 600 by receiving the random number 610 sent by the opposite secure token. The received random is internally compared 620 with the random number retrieved 630 from internal storage. If an identical match is verified 640, authentication is successful 660. If an identical match is not verified 640, authentication fails 650. An identical parallel process occurs on the opposite security token. When both security tokens have verified the random numbers, the mutual authentication process is completed.

The foregoing described embodiments of the invention are provided as illustrations and descriptions. They are not intended to limit the invention to precise form described. In particular, it is contemplated that functional implementation of the invention described herein may be implemented equivalently in hardware, software, firmware, and/or other available functional components or building blocks. Other variations and embodiments are possible in light of above teachings, and it is not intended that this Detailed Description limit the scope of invention, but rather by the Claims following herein.

What is claimed:

1. A data processing system for generating at least one unique base key comprising a cryptographic device including at least one master group key, at least one security token including a unique identifier, and communication means for exchanging data between said cryptographic device and said token, wherein
said cryptographic device includes logic operator means combining said at least one master group key with said unique identifier received from said token through said communication means, producing said at least one unique base key,
said at least one security token includes data storage means for storing said at least one unique base key and cryptographic means using said stored at least one unique base key

2. The system according to claim 1, wherein said logic operator means includes an exclusive OR bit-wise operator means.

3. The system according to claim 2, wherein said unique identifier and said master group key are used as operands by said exclusive OR bit-wise operator means forming said at least one base key.

4. The system according to claim 1 further including message digest function means for digesting said unique identifier before operation by said logic operator means.

5. A method of generating at least one unique base key comprising the steps of
generating a master group key by a cryptographic device,
receiving a unique identifier from a first security token by said cryptographic device,
performing a logic operation using said unique identifier and said master group key as operands producing said at least one unique base,
operatively injecting said at least one unique base key into said first security token,
repeating said steps for at least a second security token.

6. The method according to claim 5, further comprising the steps of digesting said unique identifier using a message digest function.

7. The method according to claim 6, wherein said logic operation includes an exclusive OR bit-wise operation.

8. A system for performing symmetric keys based mutual authentications between at least two security tokens comprising:
a first secure token including a first unique identifier, a first unique base key which is a function of a master key and of said first unique identifier, first cryptography means, and first memory storage means;
a second security token including a second unique identifier, a second unique base key which is a function of said master key and of said second unique identifier, and second cryptography means compatible with said first cryptography means, second memory storage means and
communication means for exchanging data between said first and second secure tokens, wherein
said first secure token comprises first logic operator means for processing said first unique base key and said second unique identifier received from said second security token, producing a first composite group key,
said second secure token comprises second logic operator means for processing said second unique base key and said first unique identifier received from said first security token, producing a second composite group key,
said first and second composite group keys being equal.

9. The system according to claim 8 wherein said second unique identifier processed by said first logic operator means is a message digest of said second unique identifier, said first security token comprising first message digest function means for digesting said second unique identifier received using said communications means from said second security token.

10. The system according to claim 9 wherein said first unique identifier processed by said second logic operator means is a message digest of said first unique identifier, said second security token comprising second message digest function means for digesting said first unique identifier received using said communications means from said first security token.

11. The system according to claim 10 wherein said first logic operator means comprises a first exclusive OR bit-wise operator, said message digest of said second unique identifier and said first unique base key being used as operands by said first exclusive OR bit-wise operator, producing said first composite group key which is stored using said first memory storage means.

12. The system according to claim 11 wherein said second logic operator means comprises a second exclusive OR bit-wise operator, said message digest of said first unique identifier and said second unique base key being used as operands by said second exclusive OR bit-wise operator, producing said second composite group key which is stored using said second memory storage means.

13. The system according to claim 12 wherein said first security token comprises first random number generating means for generating a first random number, said first random number being stored using said first memory storage means, said first cryptographic means encrypting said first random number with said first composite group key producing a first cryptogram.

14. The system according to claim 13 wherein said second security token comprises second random number generating means for generating a second random number, said second random number being stored using said second memory storage means, said second cryptographic means encrypting said second random number with said second composite group key producing a second cryptogram.

15. The system according to claim 14 wherein said first cryptogram is sent to said second security token using said communications means and decrypted using said second composite group key and said second cryptographic means, producing a first random number result.

16. The system according to claim 15 wherein said second cryptogram is sent to said first security token using said communications means and decrypted using said first composite group key and said first cryptographic means, producing a second random number result.

17. The system according to claim 16 wherein said first random number result is sent to said first security token using said communications means, said first security token comprising first comparing means for comparing said first random number result to said first random number retrieved using said first memory storage means.

18. The system according to claim 17 wherein said second random number result is sent using said communications means to said second security token, said second security token comprising second comparing means for comparing said second random number result to said second random number retrieved using said second memory storage means.

19. The system according to claim 17 wherein a match between said first random number result and said first random number authenticates said second security token to said first security token.

20. The system according to claim 18 wherein a match between said second random number result and said second random number authenticates said first security token to said second security token.

21. The system according to claim 8 wherein said first cryptographic means and said second cryptographic means includes at least one common symmetric cryptographic algorithm.

22. A method for performing mutual authentications between a first security token and a second security token comprising:
sending a first unique identifier from a first security token to a second security token,
sending a second unique identifier from said second security token to a said first security token,
digesting said second unique identifier by said first security token using a message digest function mutually installed in said first and said second security tokens producing a second digest result,
digesting said first unique identifier by said second security token using said message digest function producing a first digest result,
performing an exclusive OR bit-wise operation by said second security token using said second digest result and a second unique base key as operands, producing a second composite group key,
performing an exclusive OR bit-wise operation by said first security token using said first digest result and a second unique base key as operands, producing a first composite group key,
generating a first random number by said first security token, storing a copy of said first random number and encrypting said first random number using said first composite group key and a mutually shared cryptographic algorithm, producing a first cryptogram,
generating a second random number by said second security token, storing a copy of said second random number and encrypting said second random number using said second composite group key and said mutually shared cryptographic algorithm, producing a second cryptogram,
sending said first cryptogram from said first security token to said second security token,
sending said second cryptogram from said second security token to said first security token,
receiving and decrypting said first cryptogram using said second composite group key and said mutually shared cryptographic algorithm by said second security token producing a first random number result,
receiving and decrypting said second cryptogram using said first composite group key and said mutually shared cryptographic algorithm by said first security token producing a second random number result,
sending said first random number result from said second security token to said first security token,
sending said second random number result from said first security token to said second security token,
receiving said first random number result by said first security token, retrieving said copy of said first random number from memory and comparing said first random number result to said copy of said first random number,
receiving said second random number result by said second security token, retrieving said copy of said second random number from memory and comparing said second random number result to said copy of said second random number,
authenticating said second security token to said first security token if said first random number result matches said copy of said first random number,
authenticating said first security token to said second security token if said second random number result matches said copy of said second random number.

23. The method according to claim 22, wherein said mutually shared cryptographic algorithm is a symmetric algorithm.

24. A program storage device readable by a machine, tangibly embodying a program of instructions executable by said machine to perform the method steps of claim 5 or 22.
